(19) United States
(12) Patent Application Publication
(10) Pub. No.: US 2015/0272258 A1
(43) Pub. Date: Oct. 1, 2015

(54) SPORTS HELMET AND PAD KIT FOR USE THEREIN

(71) Applicant: Darius J. Preisler, Macomb, MI (US)

(72) Inventor: Darius J. Preisler, Macomb, MI (US)

(21) Appl. No.: 14/739,323

(22) Filed: Jun. 15, 2015

Related U.S. Application Data
(63) Continuation-in-part of application No. 13/352,546, filed on Jan. 18, 2012.

(51) Int. Cl. A42B 3/12; G01L 5/00; G01L 1/04; A63B 71/10

(52) U.S. Cl. CPC A42B 3/127; A63B 71/10; G01L 5/0052; G01L 1/04

(57) ABSTRACT

A sports helmet and replacement pad kit for use therein are provided. The sports helmet includes an outer shell having inner and outer surfaces. A sports helmet further includes a shock absorbing liner removably disposed within the shell. The liner includes at least one replacement pad which has a plurality of spaced-apart structures which absorb energy of an impact at the outer surface of the shell by deformably crushing. The number, spacing, size, shape and material of the structures are predetermined based on level of play of the sport.

### CROSS REFERENCE TO RELATED APPLICATION

This is a continuation-in-part of application Ser. No. 13/352,546, filed Jan. 18, 2012, and published as Pub. No. US2013/0180034 A1, on Jul. 18, 2013.

### TECHNICAL FIELD

This invention relates to protective head gear and, in particular, to sports helmets and replacement pad kits for use therein.

### OVERVIEW

Professionals and amateurs alike wear protective head gear to reduce the chance of injury while playing American football. The sport of football requires the use of helmets to attempt to protect participants from injury to their heads due to impact forces that may be sustained during such activities. Various types of helmets have been in use in the sport of football, ever since individuals began wearing helmets to attempt to protect their heads many years ago. Typically, these helmets have included: an outer shell, generally made of an appropriate plastic material, having the requisite strength and durability characteristics to enable them to be used in the sport of football; some type of shock absorbing liner within the shell; a face guard; and a chin protector, or chin strap, that fits snugly about the chin of the wearer of the helmet, in order to secure the helmet to the wearer's head, as are all known in the art.

Sources are unsure as to who first designed air bladders for football helmets but Dr. Richard Schneider of the University of Michigan Hospital is reported to have believed that air was the most effective way to protect against blunt force. With this theory in mind, he invented an inflatable bladder for use inside a football helmet. The Michigan Wolverines Football team used a prototype and Schutt Sports hired Schneider and started mass producing the Air™ Helmet in the early 1970s.

While larger helmets and extra padding may reduce the force of a blunt impact, lightness and breathability of the helmet are also important issues at all levels of play. Consequently, there is a need for a sports helmet which not only reduces the force of a blunt impact but also is relatively light and breathes. There is also a need to make such helmets easily adjustable based on the level of play of the sport.

The following U.S. patent documents are related to protective head gear: U.S. Pat. Nos. 2,359,387; 3,609,764; 3,713,640; 3,882,547; 4,287,613; 5,035,009; 5,175,889; 5,263,203; 6,240,571; 6,314,586; 6,934,971; 7,240,376; 2008/0120764 and 2009/0222964.

The following U.S. patents are related to automotive energy-absorbing structures: U.S. Pat. Nos. 6,475,937 and 7,201,434.

The following U.S. patent documents are related to honeycomb sandwich composite laminates and methods and systems for making structures using such laminates: U.S. Pat. Nos. 6,050,630; 6,435,577; 6,437,413; 6,655,299; 6,682,675; 6,682,676; 6,748,876; 6,790,026; 6,823,803; 6,843,525; 6,890,023; 6,981,863; 7,909,379; 7,919,031; 2005/0189674 and 2010/0006520.

### SUMMARY OF EXAMPLE EMBODIMENTS

In one embodiment, a sports helmet includes an outer shell which has inner and outer surfaces. The sports helmet includes a shock absorbing liner removably disposed within the shell. The liner includes at least one replacement pad which has a plurality of spaced-apart structures which absorb energy of an impact at the outer surface of the shell by deformably crushing. The number, spacing, size, shape and material of the structures are predetermined based on level of play of the sport.

The at least one pad may include a cellular core and each of the structures may be a cell.

Each cellular core may be a honeycomb core.

The honeycomb core may be a thermoplastic honeycomb core.

Each core may have top and bottom surfaces and at least one of the top and bottom surfaces may include a skin layer.

The skin layer may be a thermoplastic skin layer.

The thermoplastic skin layer may be a reinforced thermoplastic skin layer.

The thermoplastic skin layer may be reinforced with fibers.

The cellular core may have an open-cell structure of the tubular or honeycomb cell type.

The material of the structure may be one of plastic, metal and cardboard.

In another embodiment, a replacement pad kit from which at least one replacement pad is selected and arranged in a shock absorbing liner removably disposed in an outer shell of a sports helmet is provided. The kit includes a plurality of replacement pads. Each of the pads has a plurality of spaced-apart structures which absorb energy of an impact at an outer surface of the outer shell by deformably crushing. The number, spacing, size, shape and material of the structures are predetermined based on level of play of the sport.

Each of the pads may include a cellular core and each of the structures may be a cell.

Each cellular core may be a honeycomb core.

The honeycomb core may be a thermoplastic honeycomb core.

Each core may have top and bottom surfaces and at least one of the top and bottom surfaces may include a skin layer.

The skin layer may be a thermoplastic skin layer.

The thermoplastic skin layer may be a reinforced thermoplastic skin layer.

The thermoplastic skin layer may be reinforced with fibers.

The cellular core may have an open-cell structure of the tubular or honeycomb cell type.

The material of the structures may be one of plastic, metal and cardboard.

In yet another embodiment, the cellular core is in the form of the tubular or honeycomb cell type, and is interposed between the inner wall of the helmet and a conventional elastically-deformable pad, in a layered construction.

In this embodiment, the tubular or honeycomb cell type of core is preferably molded of translucent polypropylene, and is plastically-deformable in response to an impact force.

In this embodiment, the cellular core is removable and may be measured, visually and/or dimensionally, for plastic deformation in proportion to the impact force of a wearer's head on the sandwiched construction.

Objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a perspective view of a football helmet of the University of Michigan which has been modified to use a replacement pad kit and shock absorbing liner constructed in accordance with at least one embodiment of the present invention;

FIG. 2 is a bottom view of the helmet of FIG. 1 which shows a unitary inner head support and various replacement pads of a shock absorbing liner removably disposed within an outer shell of helmet;

FIG. 3 is a view similar to the view of FIG. 2 with the shock absorbing liner and unitary support in FIG. 2 removed for illustrative purposes;

FIG. 4 is a perspective view of a replacement lower front pad of FIG. 2;

FIG. 5 is a sectional view of the front pad taken along lines 5-5 of FIG. 4;

FIG. 6 is a perspective view of a replacement lower back pad of FIG. 2;

FIG. 7 is a sectional view of the back pad taken along lines 7-7 of FIG. 6;

FIG. 8 is a perspective view of one of the replacement lower side pads of FIG. 2;

FIG. 9 is a sectional view of the lower side pad taken along lines 9-9 of FIG. 8;

FIG. 10 is an exploded perspective view of a replacement removable upper front padding group of FIG. 2 including a side replacement pad constructed in accordance with at least one embodiment of the present invention; and

FIG. 11 is a sectional view of the side replacement pad taken along lines 11-11 of FIG. 10.

FIG. 12 is a partial sectional view of an embodiment in which the cellular core is removably interposed between the inner helmet wall and a pad, in a sandwich construction;

FIG. 13 is a side view, in cross-section, of an impacted cellular core showing the deformation and reduced translucence of the cell wall subjected to impact by the wearer's head; and

FIG. 14 is a schematic view of a gage with graduated markings used to measure the impact force of the wearer's head based on crushing or deformation of the cell walls.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

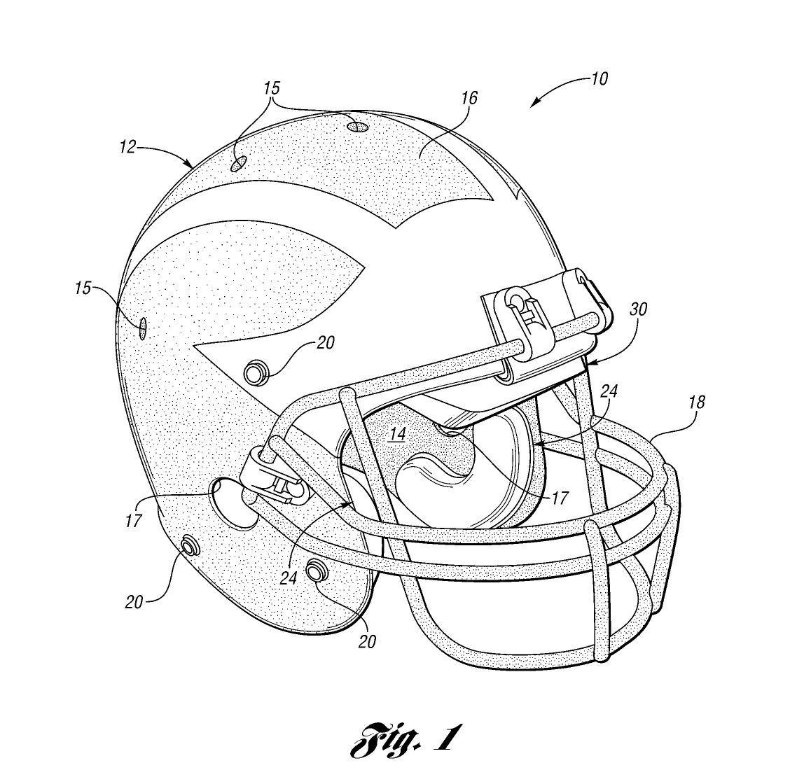

Referring to FIGS. 1-3, there is illustrated a sports helmet in the form of a football helmet, generally indicated at 10, constructed in accordance with the present invention. The helmet 10 includes an outer shell 12 having inner and outer surfaces 14 and 16, respectively. The outer shell 12 is typically made of a plastic material having the requisite strength and durability characteristics to enable the shell 12 to be used in the sport (i.e. football). For breathability, the outer shell includes upper air holes 15 and ear holes 17 formed completely through the shell 12 between the inner and outer surfaces 14 and 16.

The helmet 10 also includes at least one shock absorbing liner or padding, a face guard 18 and a chin protector or snap (not shown) which is removably attached to the shell 12 at snaps 20.

The shock absorbing liner or padding preferably includes a plurality of replaceable pads, some of which may be interconnected to form padding groups. Some pads typically are removably secured or fastened to the inner surface 14 of the shell 12 by snap fasteners or Velcro fasteners. Other pads and padding groups are removably secured within the shell in an interference fit fashion.

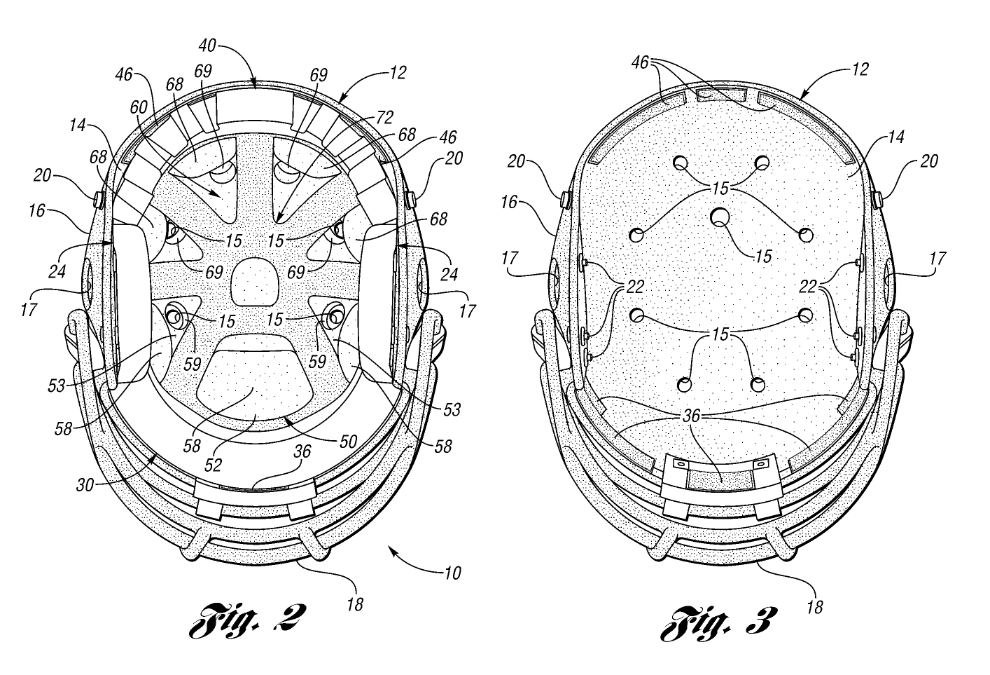

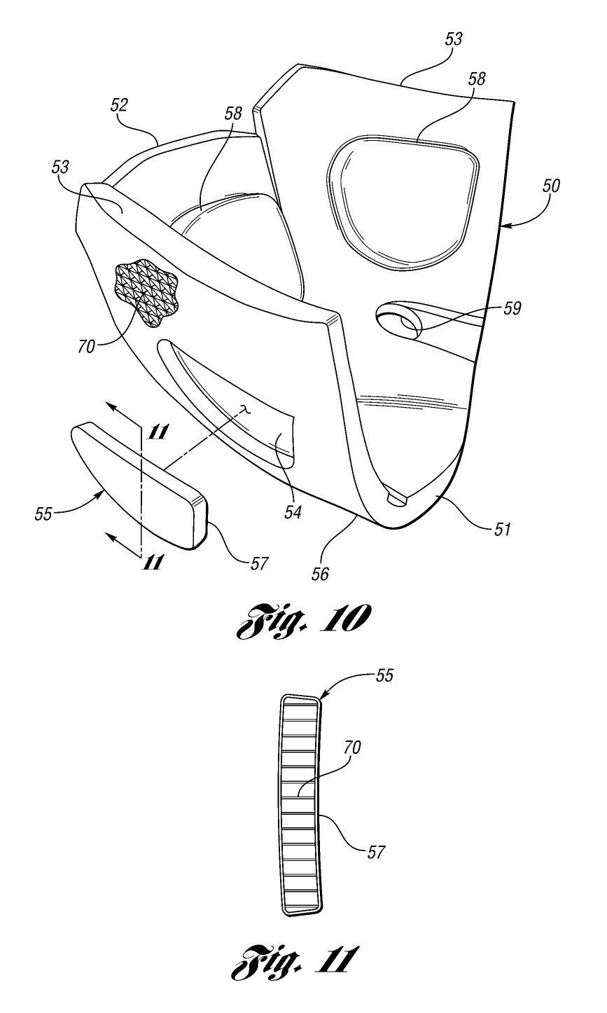

Snap fastener parts 22 (FIG. 3) for replaceable lower side pads, generally indicated at 24 in FIGS. 1, 2, 8 and 9, are secured at spaced locations on the inner surface 14 of the shell 12 adjacent the ear holes 17. Complementary snap fastener parts 26 are formed at corresponding spaced locations on a breathable outer surface layer 28 of the pad 24 as shown in FIGS. 8 and 9.

The liner or padding also includes a replaceable lower front pad, generally indicated at 30 in FIGS. 1, 2, 4 and 5. The front pad 30 has hook and loop fastener material 32 formed at spaced locations on a breathable outer surface layer 34 of the pad 30 which releasably fastens the pad 30 to hook and loop fastener material 36 formed at corresponding spaced locations on the inner surface 14 of the shell 12.

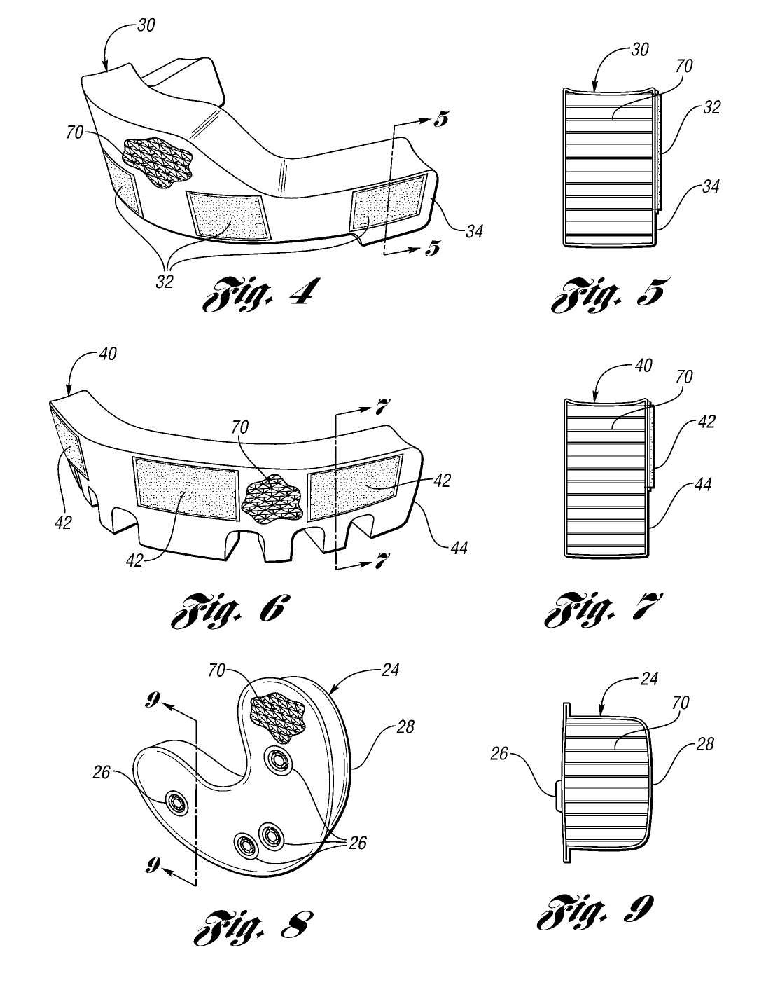

The liner or padding also includes a replaceable lower back pad, generally indicated at 40 in FIGS. 2, 6 and 7. The back pad 40 also has hook and loop fastener material 42 formed at spaced locations on an outer surface layer 44 of the pad 40 which releasably fastens the pad 40 to hook and loop fastener material 46 formed at corresponding spaced locations on the inner surface 14 of the shell 12.

The liner or padding further includes a replaceable upper front padding group, generally indicated at 50 in FIGS. 2, 10 and 11 and a replaceable upper back padding group, generally indicated at 60 in FIG. 2, which are fit together in mating relationship to form an upper liner or padding assembly. The assembly is held in the shell 12 by the pads 24, 30 and 40 and by a removable, unitary inner plastic head support, generally indicated at 72 in FIG. 2, which engages and directly supports the wearer's head.

Referring specifically to FIGS. 10 and 11, the upper front padding group 50 includes a base member 51 having a flexible pad or flap 52 and flexible side pads or flaps 53 hingedly formed therewith. Each of the flaps 52 and 53 has a pocket 54 formed therein to removably receive and retain a replacement pad 55 therein. The front padding group 50 has a breathable outer surface layer 56 and the replacement pad 55 also has a breathable outer surface layer 57. Each of the pockets 54 extends into its respective flap 52 or 53 on one side thereof and forms mounds 58 which extend above the inner surface of its respective flap 52 or 53. The base member 51 includes holes 59 which register with the holes 15 in the shell 12 for breathability.

While not shown in detail (but similar to the front padding group 50), the back padding group 60 also includes flexible pads or flaps integrally and hingedly formed with a base member. Each of the flaps has a pocket formed therein to removably receive and retain a replacement pad similar to the replacement pad 55 therein. Each of the pockets extends into its respective flap or pad on one side thereof, and form mounds 68 (FIG. 2) which extend above the inner surface of their respective flaps of the padding group 60. The base member also includes holes 69 which register with the holes 15 of the shell 12 for breathability as also shown in FIG. 2.

Referring now to FIGS. 4-11, each of the replacement pads 55, as well as each of the pads 24, 30 and 40 and each of the pads or flaps 52 and 53, has a plurality of spaced-apart structures 70 which absorb energy of an impact at the outer surface 16 of the shell 12 by deformably crushing. The number, spacing, size, shape and material of the structures 70 are predetermined based on level of play of the sport. For example, the amount of energy that needs to be absorbed by having the structures 70 deformably crush is much lower at the grade school and high school levels than the college and professional levels.

Preferably, each of the replacement pads 55, the pads 24, 30 and 40 and the pads or flaps 52 and 53 have a cellular core wherein each of the structures is a cell. The cellular core may be a honeycomb core and the honeycomb core may be made out of thermoplastic. The cellular core may have an open cell structure of the tubular or honeycomb cell type to promote or facilitate breathability. The material of the structures is typically one of plastic (such as a polyolefin like polypropylene) metal and cardboard depending on the level of play of the sport. While not shown, the top and/or bottom surface of each core may have a skin layer formed thereon. The skin layer may be a thermoplastic skin layer. The thermoplastic skin layer may be reinforced by, for example, fibers.

Each cellular core may be made as disclosed in the above-noted U.S. Pat. No. 7,919,031, or the prior art cited therein. The cells may have the configuration of FIGS. 4, 6, 8 and 10 (i.e. triangular) or the cells may form a honeycomb including cylindrical, hexagonal, or square cells. Other shapes are also possible such as waves. The axes of the cells are perpendicular to the outer surfaces of the core as well as any skin layers of the core. Cell density (i.e. cell size and wall stock) is adjusted as needed for expected impact force at the level of play of the sport. The open cells typically have a diameter in a range of 2 mm to 10 mm and the thicknesses of the cellular core is typically between 5 mm and 30 mm depending on the level of play of the sport.

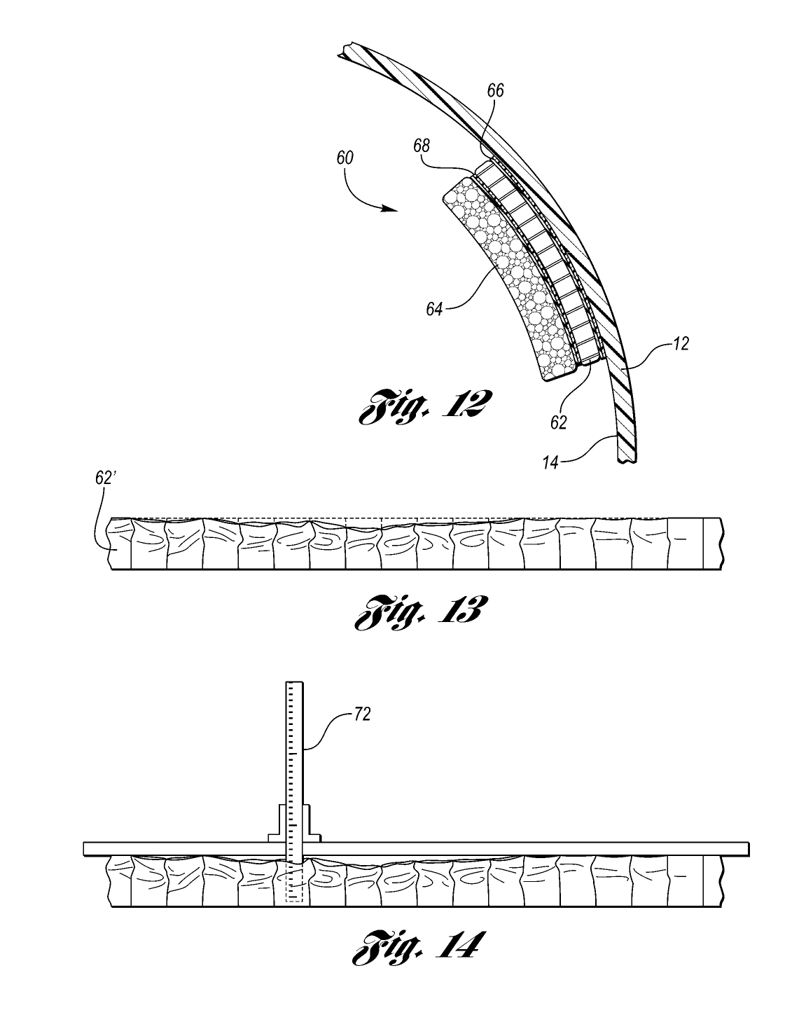

FIG. 12 shows yet another embodiment in which a cellular core 62 is interposed between the inner wall or surface 14 of the helmet shell 12, and a conventional elastically- deformable pad, e.g., foam pad, 64, to form an energy-absorbing, layered construction, indicated generally at 60.

The cellular core 62 is removably secured to the surface 14 and the pad 64, such as by hook-and-pile fasteners 66 and 68.

In the preferred embodiment, the cellular core is a honeycomb core molded of clear or translucent thermoplastic, such as a polyolefin like polypropylene.

FIG. 13 is a side view of an impacted cellular core component 62′ removed from the layered construction 60.

The walls of the cellular core component 62′ are plastically-deformable in proportion to the impact force of the wearer's head on the layered construction 60.

FIG. 14 shows a gage 72 in the form of a probe with graduated markings used to measure the impact force of the wearer's head based on crushing, i.e., plastic deformation of the cell walls.

The gage 72 can be calibrated by bench testing using instrumented head forms using the helmet manufacturer's fitting instructions, and by dropping the helmet at specified velocities and specified helmet locations onto a test pad. The severity of the impact to the head form on each drop can be measured, and correlated to the crushing or deformation of the cellular core.

Alternatively, if the cellular core component 62 is formed of a translucent plastic material, the reduced translucence of the material upon deformation can be indexed to the impact force. Deformed polypropylene exhibits a “milky” appearance, with the degree of reduced translucence proportional to the impact force.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A sports helmet comprising:
an outer shell having inner and outer surfaces; and
an energy absorbing liner, removably disposed within the shell, the liner formed of a layered construction with a layer having a cellular core that is plastically-deformable, positioned proximate the inner surface of the shell, and a layer having padding that is elastically-deformable, position proximate the wearer's head.

2. The helmet as claimed in claim 1, wherein the cellular core is plastically-deformable in proportion to the impact force of the wearer's head on the liner.

3. The helmet as claimed in claim 2, wherein each cellular core is a honeycomb core.

4. The helmet as claimed in claim 3, wherein the honeycomb core is a thermoplastic honeycomb core.

5. The helmet as claimed in claim 2, wherein the cellular core has an open-cell structure of the tubular or honeycomb cell type.

6. The helmet as claimed in claim 1, wherein the cellular core is formed of a material that is substantially translucent in its pre-deformed condition.

7. The helmet as claimed in claim 1, wherein the cellular core is formed of a material that is substantially translucent in its pre-deformed condition, and of reduced translucence when plastically deformed by an impact force.

8. The helmet as claimed in claim 1, wherein the cellular core is formed of a material that is substantially translucent in its pre-deformed condition, and of reduced translucence when plastically deformed by an impact force of the wearer's head on the liner, and wherein the reduction in translucence is proportional to the impact force.

9. A replacement pad kit from which at least one replacement pad is selected and arranged in a shock absorbing liner removably disposed in an outer shell of a sports helmet, the kit comprising:
an energy absorbing liner, removably disposed within the shell, the liner formed of a layered construction with a layer having a cellular core that is plastically-deformable, positioned proximate the inner surface of the shell, and a layer having padding that is elastically-deformable, position proximate the wearer's head.

10. The kit as claimed in claim 9, wherein the cellular core is plastically-deformable in proportion to the impact force of the wearer's head on the liner.

11. The kit as claimed in claim 9, wherein each cellular core is a honeycomb core.

12. The kit as claimed in claim 11, wherein the honeycomb core is a thermoplastic honeycomb core.

13. The kit as claimed in claim 9, wherein the cellular core is formed of a material that is substantially translucent in its pre-deformed condition.

14. The kit as claimed in claim 9, wherein the cellular core is formed of a material that is substantially translucent in its pre-deformed condition, and of reduced translucence when plastically deformed by an impact force.

15. The kit as claimed in claim 14, wherein the cellular core is formed of a material that is substantially translucent in its pre-deformed condition, and of reduced translucence when plastically deformed by an impact force of the wearer's head on the liner, and wherein the reduction in translucence is proportional to the impact force.

16. A gage for use with a sports helmet having an outer shell, and an energy absorbing liner, removably disposed within the shell, the liner having a cellular core that is plastically-deformable, the gage comprising a probe with graduated markings that correlate to the level of impact force that cause plastic deformation of the cellular core.
